(19) United States
(12) Patent Application Publication
(10) Pub. No.: US 2010/0129103 A1
(43) Pub. Date: May 27, 2010

(54) IMAGE FORMING APPARATUS

(76) Inventors: Satoshi Ogata, Tokyo (JP); Jun Onishi, Tokyo (JP); Shinpei Kawasaki, Hiratsuka-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/621,219

(22) Filed: Nov. 18, 2009

(30) Foreign Application Priority Data
Nov. 21, 2008 (JP) JP2008-297657

(51) Int. Cl. G03G 15/16

(52) U.S. Cl. 399/66

(57) ABSTRACT

An image forming apparatus, comprises an image carrying member for carrying a toner image; a drive section for driving the image carrying member at a predetermined speed; a transfer section for forming a transfer region with the image carrying member therebetween in which the transfer section nips a sheet of recording paper with the image carrying member so as to transfer the toner image on the image carrying member to the sheet of recording paper; a memory section for memorizing control data to suppress speed fluctuation which is caused on the image carrying member when the sheet of recording paper passes the transfer region; and a control section to control the drive section based on the control data memorized in the memory section such that the drive section applies torque with a phase reverse to that of the speed fluctuation onto the image carrying member.

This application is based on Japanese Patent Application No. 2008-297657 filed on Nov. 21, 2008, in Japanese Patent Office, the entire content of which is hereby incorporated by reference.

### BACKGROUND OF THE INVENTION

The present invention relates to an image forming apparatus, such as a copying machine and a printer. Especially, the present invention relates to countermeasures to the case that sudden speed fluctuation is caused on the conveying speed of a sheet of recording paper (or a recording sheet) or the speed of an image carrying member by impulsive vibration occurring at the time that a sheet of recording paper plunges into or leaves from a transfer region in which the sheet of recording paper is pinched and conveyed.

There exists an image forming apparatus in which a toner image on an image carrying member is transferred to a sheet of recording paper while the sheet of recording paper is pinched and conveyed in a transfer region formed between an image carrying member and a transfer section (transfer roller). In such an image forming apparatus, it is well known that vibration occurs at the time that a sheet of recording paper passes (plunges into or leaves from) through a transfer region constituted such that a transfer section comes in contact with an image carrying member, successively the vibration causes speed fluctuation instantaneously on the speed of the image carrying member, and eventually, the speed fluctuation of the image carrying member causes an adverse effect on a toner image being formed.

In this case, if the thickness of a sheet of recording paper becomes thicker, speed fluctuation is generated more easily by vibration at the time that the sheet of recording paper plunges into or leaves from the transfer region. Subsequently, this speed fluctuation may cause conspicuous deterioration in image quality, although it occurs locally, such as transfer errors in image registration at the transfer section and exposure unevenness in an exposed image.

Patent documents, such as Japanese Patent Unexamined Publication No. 10-268595, and Japanese Patent Unexamined Publication No. 322786, propose the countermeasures to instantaneous speed fluctuation of an image carrying member caused, as mentioned above, by vibration occurring at the time of conveying a sheet of recording paper while pinching it.

Both the above-mentioned patent documents disclose a technique to adjust the stretched condition of a transfer belt on supporting rollers such that the transfer belt is provided with sag to absorb vibration, whereby the technique tends to weaken the influence of the above-mentioned impulsive vibration. However, it is not desirable to provide a belt with sag, because the slip of the belt may take place.

Further, as general ideas, it is theoretically possible to cope with the above problems by increasing the mechanical rigidity of an apparatus so as not to cause the above-mentioned vibration. However, actually, from the points with regard to the size of the apparatus, the installing location and cost of a flywheel and the cost of the entire portion of the apparatus, it may be difficult to increase the mechanical rigidity more than that at the present time.

Also, as general ideas, in order to prevent the above-mentioned vibration from occurring, a soft roller capable of absorbing an impact shock is employed as a transfer roller and a conveying roller on each part, whereby it becomes possible to absorb an impact shock at the time that a sheet of recording paper plunges into or leaves the roller. However, from the points with regard to transfer efficiency and image quality, it is not desirable to employ such a soft roller as a transfer roller in the transfer section.

### SUMMARY OF THE INVENTION

The present invention has been made to solve the above problems, that is, an object of the present invention is to provide an image forming apparatus capable of preventing appropriately image quality from deteriorating due to speed fluctuation caused suddenly on the conveying speed of a sheet of recording paper or the speed of an image carrying member by impulsive vibration occurring at the time that a sheet of recording paper plunges into or leaves from a transfer region in which the sheet of recording paper is pinched and conveyed.

The above object can be attained by the following structure to which one aspect of the present invention is reflected.

An image forming apparatus, comprises:

an image carrying member for carrying a toner image;

a drive section for driving the image carrying member at a predetermined speed;

a transfer section for forming a transfer region with the image carrying member therebetween in which the transfer section nips a sheet of recording paper with the image carrying member so as to transfer the toner image on the image carrying member to the sheet of recording paper;

a memory section for memorizing control data to suppress speed fluctuation which is caused on the image carrying member when the sheet of recording paper passes the transfer region formed between the image carrying member and the transfer section; and

a control section to control the drive section based on the control data memorized in the memory section such that the drive section applies torque with a phase reverse to that of the speed fluctuation onto the image carrying member.

### BRIEF DESCRIPTION OF THE DRAWINGS

FIG. 1 is a structural view showing a structure of an image forming apparatus in an embodiment of the present invention.

FIGS. 2a and 2b each is a structural view showing a structure of an image forming apparatus in an embodiment of the present invention.

FIG. 3a is a diagram showing a timing at which speed fluctuation is caused in the course of the passage of a sheet of recording paper in a transfer region, and FIG. 3b and FIG. 3c each is a table in which speed fluctuation data are indicated.

FIG. 4 is a flow chart for explaining operational conditions of an image forming apparatus in an embodiment of the present invention.

FIGS. 5a through 5f are time charts for explaining operational conditions of an image forming apparatus in an embodiment of the present invention.

FIGS. 6a thorough 6f are time charts for explaining operational conditions of an image forming apparatus in an embodiment of the present invention.

FIGS. 7a through 7f are time charts for explaining operational conditions of an image forming apparatus in an embodiment of the present invention.

FIG. 8 is a flow chart for explaining operational conditions of an image forming apparatus in an embodiment of the present invention.

### DETAILED DESCRIPTION OF THE PREFERRED EMBODIMENT

Hereafter, preferable embodiments of the preset invention will be explained. However, the present invention is not necessarily limited to these embodiments.

Firstly, the best mode (preferable embodiment) will be explained in detail with reference to the drawings.

### First Embodiment

### Structure of the First Embodiment

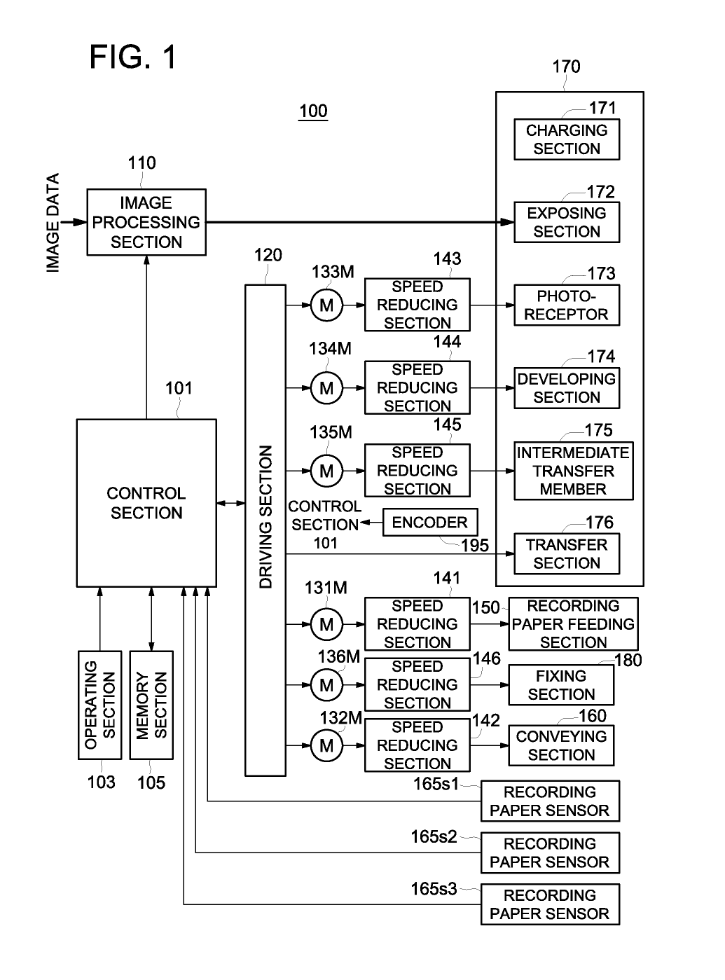

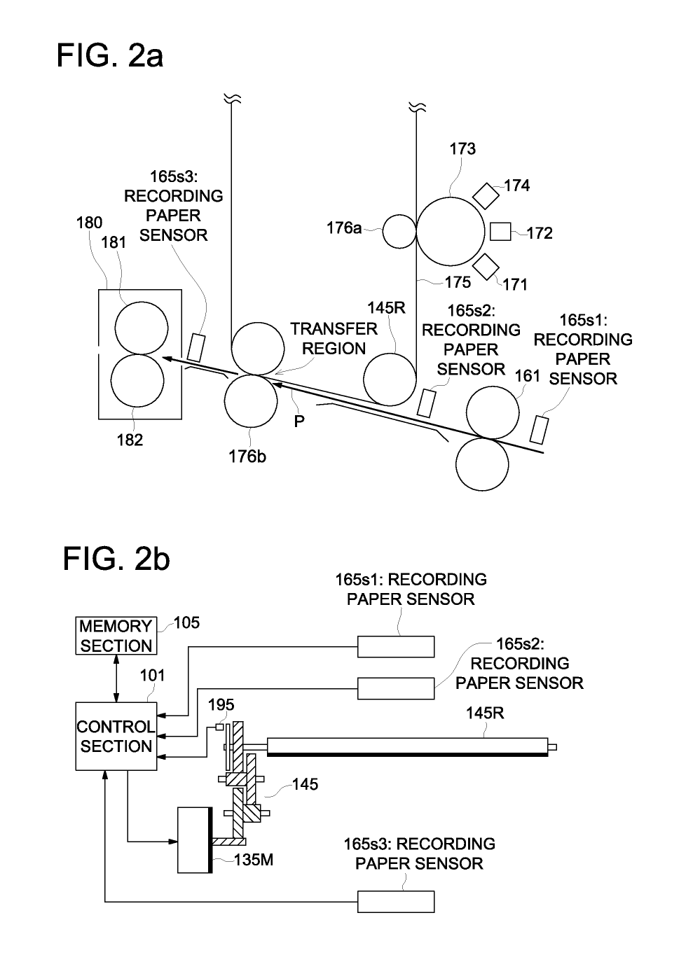

Hereafter, the structure of an image forming apparatus 100 according to the first embodiment will be explained in detail based on FIG. 1 and FIG. 2. Specifically, the electrical structure of the image forming apparatus 100 according to the first embodiment is explained based on FIG. 1, and the mechanical structure is explained based on FIG. 2.

The explanation is omitted for a general structure which is well known in the field of the image forming apparatus and has nothing to do directly with the distinctive operations and controls of this embodiment. In the image forming apparatus 100, a control section 101 is constituted with a CPU in order to control each section of the image forming apparatus 100. When a sheet of recording paper passes through a transfer region formed between an image carrying member and a transfer section, vibration occurs on the transfer region. The vibration causes successively fluctuation (speed fluctuation) on the predetermined speed of the image carrying member. In this case, the control section 101 has a function to give a drive section an instruction to apply torque with a reverse phase at a predetermined timing to the image carrying member.

An operating section 103 is used to input various operations by an operator at the time of a process of forming toner images, and, for example, operations to select a kind of recording paper or a paper feeding tray at the time of a process of forming toner images are conducted at the operating section 103, and information about the operations is sent to the control section 101.

A memory section 105 memorizes various data, such as, in this embodiment, the data of speed fluctuation generated at the time that a sheet of recording paper plunges into or leaves from a transfer region, and the data (control data) of a motor driving signal necessary to apply the reverse phase torque with a proper level (level near the amplitude of speed fluctuation) at a proper timing (the same timing as the generation of speed fluctuation) against speed fluctuation detected for each kind of recording paper.

An image processing section 110 conducts an image processing for image data to form an image so as to make it to a condition suitable for forming an image. A drive section drives each of the following motors to rotate at the respective predetermined number of rotations.

A motor 131M is a drive source to rotate a paper feeding roller of a paper feeding section 150. A motor 132M is a drive source to rotate a conveying roller of a conveying section 160. A motor 133M is a drive source to rotate a photoreceptor 173 such as a photoreceptor drum. A motor 134M is a drive source to rotate a developing roller of a developing section 174. A motor 135M is a drive source to rotate an intermediate transfer member 175. These motors 131M to 135M is collectively called a motor 130M.

A speed reducing section 141 is a speed reducing mechanism at the time of rotating a feeding roller of a paper feeding section 150 at predetermined speed by a rotating force of the motor 131M. A speed reducing section 142 is a speed reducing mechanism at the time of rotating a conveying roller at each section of a conveying section 160 at predetermined speed by a rotating force of the motor 132M. A speed reducing section 143 is a speed reducing mechanism at the time of rotating a photoreceptor section 173 such as a photoreceptor drum at predetermined speed by a rotating force of the motor 133M. A speed reducing section 144 is a speed reducing mechanism at the time of rotating a developing roller of a developing section 174 at predetermined speed by a rotating force of the motor 134M. A speed reducing section 145 is a speed reducing mechanism at the time of rotating an intermediate transfer member 175 at predetermined speed by a rotating force of the motor 135M. These speed reducing sections 141 to 143 are collectively called a speed reducing section 140.

The paper feeding section 150 feeds out a sheet of recording paper stored in plural paper feeding trays with a feeding roller to a conveying section 160. The conveying section 160 is equipped with a registering roller 161 or various kinds of conveying rollers in order to convey the sheet of recording paper fed out from the paper feeding section 150 at a predetermined conveying speed. The registering roller 161 is arranged at the upstream side of a transfer region and conveys a sheet of recording paper to the transfer region while pinching the sheet of recording paper.

Moreover, recording paper sensors 165s (165s1, 165s2, 165s3, . . . 165sn,) to detect the passage of a sheet of recording paper are arranged in the predetermined positions on the conveyance path of the conveying section 160, and the detection result is transmitted to the CPU 101.

FIG. 2 shows the situation that the recording paper sensor 165s1 is arranged at the upstream side of the registering roller on the conveyance path, the recording paper sensor 165s2 is arranged the downstream side of the registering roller and at the upstream side of an intermediate transfer member driving roller, and the recording paper sensor 165s3 is arranged at the upstream side of a fixing roller.

A process unit 170 is an image forming unit for conducting various actions to form an image on a sheet of recording paper, and is equipped with a photoreceptor section 173 which rotates in a predetermined direction, a charging section 171 which electrically charges a photoreceptor 173 to a predetermined electric potential, an exposing section 172 which exposes the charged photoreceptor 173 in accordance with image data, a developing section 174 which develops an electrostatic latent image formed on the photoreceptor section 173 by the exposure and forms a toner image, an intermediate transfer member 175 as an image carrying member which carries a toner image transferred from the photoreceptor 173, and a transfer section 176 which has a transfer roller 176a and a transfer roller 176b.

The rotational force of the motor 135 is transmitted to an intermediate transfer member driving roller 145R through the speed reducing section 145, and the intermediate transfer member 175 is driven by the intermediate transfer member driving roller 145R so at to rotate at a predetermined speed (refer to FIG. 2a and FIG. 2b). In the transfer section 176, the transfer roller 176a is used to transfer a toner image from the photoreceptor 173 onto the intermediate transfer member 175, and the transfer roller 176b is used to transfer a toner image on the intermediate transfer member 175 onto a sheet of recording paper.

Concretely, in the transfer region of this embodiment, a sheet of recording paper is pinched and conveyed between the transfer roller 176b as the transfer section and the intermediate transfer members 175 as an image carrying member, whereby a toner image is transferred from the image carrying member to a sheet of recording paper.

The fixing section 180 is located downstream of the transfer roller 176b, and pinches and conveys the sheet of recording paper, thereby fixing the toner image onto the sheet of recording paper. An encoder (speed detecting section) 195 is mounted on the driving shaft of the intermediate transfer member driving roller 145R in order to detect speed fluctuation of the intermediate transfer member 175 (refer to FIG. 2b), and the detection result of the encoder 195 is transmitted to the CPU 101.

Among speed fluctuation data used to cope with speed fluctuation corresponding to each kind of recording paper, the amount of speed fluctuation is detected and stored in the memory section 105 at the time of preliminary adjustments in a factory before shipment or at the time of initial operations in a user's service site.

In order to acquire such the amount of speed fluctuation, a sheet of recording paper is made to pass through the transfer region, and the encoder 195 detects speed (speed fluctuation) of the intermediate transfer member driving roller 145R during the passage of the sheet of recording paper. Namely, the encoder 195 detects speed fluctuation of the intermediate transfer member driving roller 145R generated along with impulsive vibrations caused by the passage of the sheet of recording paper through the transfer region, and the control section 101 acquires the amount of speed fluctuation from the encoder 195.

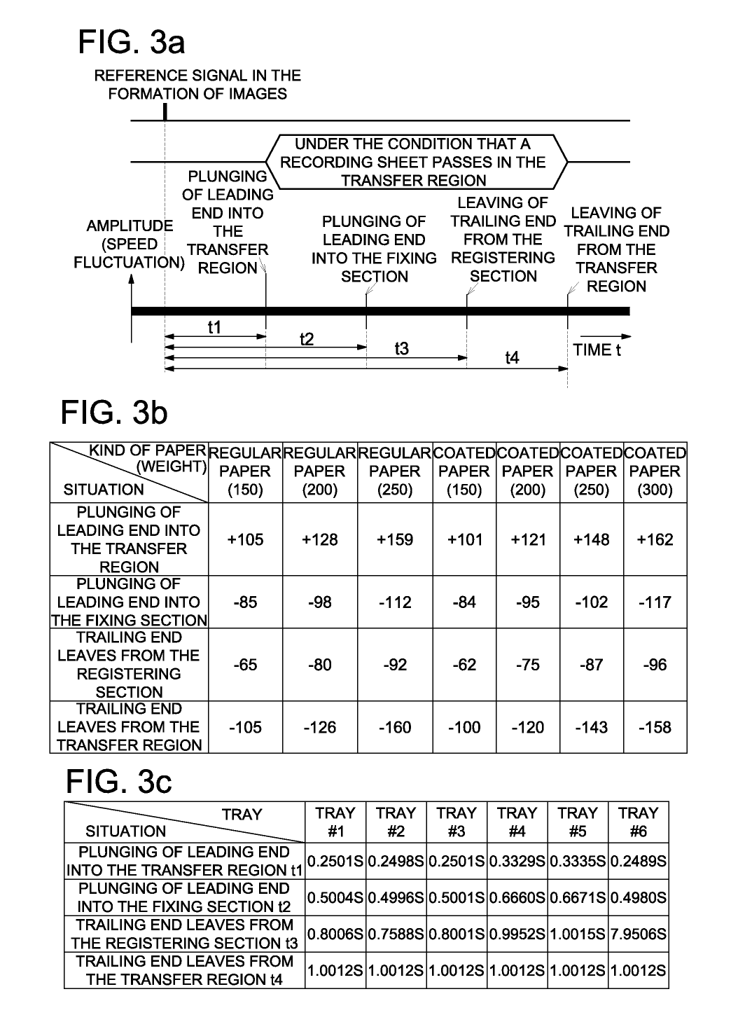

In this measurement, for each state at the time that the leading end of a sheet of recording paper plunges into the transfer region on the condition that the transfer roller 176b is in contact with the intermediate transfer member 175, at the time that the leading end of the sheet of recording paper plunges into the fixing section while the sheet of recording paper is pinched in the transfer region, at the time that the trailing end of the sheet of recording paper leaves from a registering section while the sheet of recording paper is pinched in the transfer region, and at the time that the sheet of recording paper leaves from the transfer region, the amount of speed fluctuation (FIG. 3a) is detected for each kind of recording paper, and stored in the memory section 105 as data in a table shown in FIG. 3b.

At the time that the leading end of a sheet of recording paper plunges into the transfer region on the condition that the transfer roller 176b is in contact with the intermediate transfer member 175, since the leading end of the sheet of recording paper pushes up the transfer roller 176b, it is considered that the speed fluctuation on the intermediate transfer member driving roller 145R is influenced by the thickness of the sheet of recording paper. Here, the thickness of recording paper is represented with its basic weight (nominal weight or weight in a predetermined size). However, depending on difference in the density of recording paper, the basic weight is not proportional perfectly to the thickness. Therefore, the data of speed fluctuation corresponding to each kind of recording paper has been acquired in advance on the basis of the difference in paper quality such as regular paper and coated paper in addition to the respective basic weights. Actually, speed fluctuation data such as the amount of speed fluctuation may be stored as control data. Alternatively, a braking signal (speed fluctuation canceling waveform control signal) to apply reverse phase torque to generate speed components with a reverse phase speed fluctuation canceling waveform is produced based on the waveform of the obtained speed fluctuation, and the data of the braking signal may be stored as control data.

Further, when plural kinds of recording paper are set in paper feeding trays of the image forming apparatus, it is desirable that the control section 101 correlates the control data such as the speed fluctuation data of each kind of recording paper with a paper feeding tray accommodating the corresponding kind of recording paper. For such a purpose, the operating section 103 is adapted to set or input the feature of recording paper, that is, the specification data of the recording paper (such as type (regular paper or coated paper), weight, size and the like), and the control section 101 is adapted to set the control data such as the speed fluctuation data corresponding to the kind of recording paper for each of the plural kinds of recording paper accommodated respectively in the plural feeding paper trays. Then, the control section 101 makes the memory section to memorize the correspondence relationship between each of the plural feeding paper trays and the control data based on the feature (the specification data) of the recording paper accommodated in each of the plural paper feeding trays.

The amount of speed fluctuation corresponding to each kind of recording paper may be memorized in advance at the time of shipment in a factory or may be measured and memorized at the time of initial operations in a user's service site.

Moreover, in the same way, for each state at the time that the leading end of a sheet of recording paper plunges into the transfer region on the condition that the transfer roller 176b is in contact with the intermediate transfer member 175, at the time that the leading end of the sheet of recording paper plunges into the fixing section while the sheet of recording paper is pinched in the transfer region, at the time that the trailing end of the sheet of recording paper leaves from a registering section while the sheet of recording paper is pinched in the transfer region, and at the time that the sheet of recording paper leaves from the transfer region, a generation timing (t1 through t4 as shown in FIG. 3a) of speed fluctuation of each kind of recording paper is detected based on a predetermined reference signal (for example, a reference signal for a process of forming toner images, etc.) and is stored in the memory section 105 as data in a table as shown in FIG. 3c. This generation timing of speed fluctuation is detected at the time of initial operation in a user's service site as mentioned later.

### Operations in the Structure of the First Embodiment

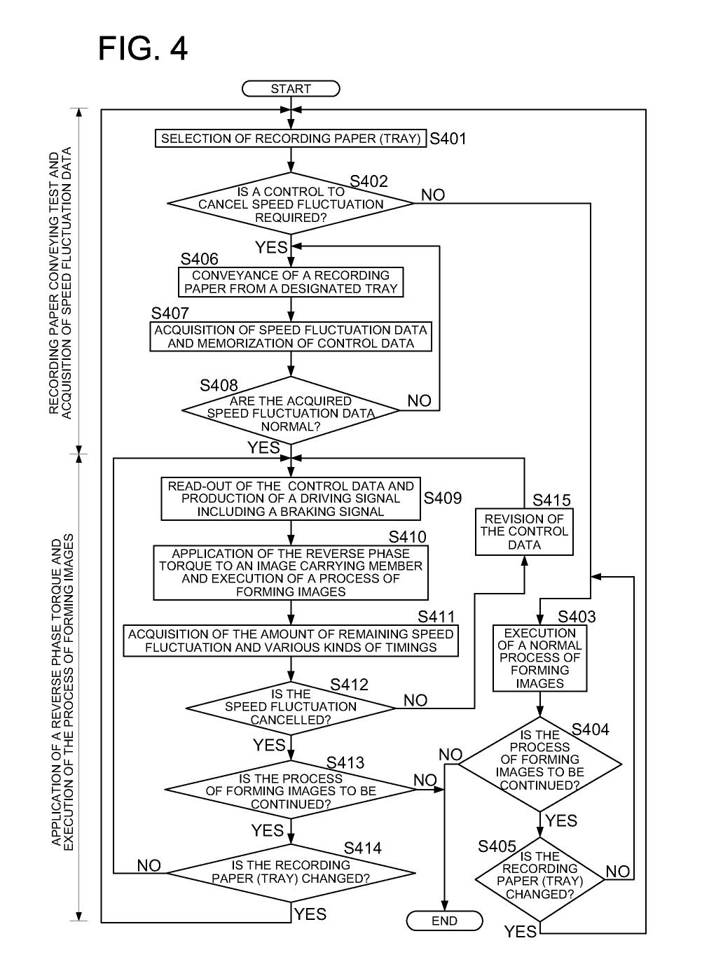

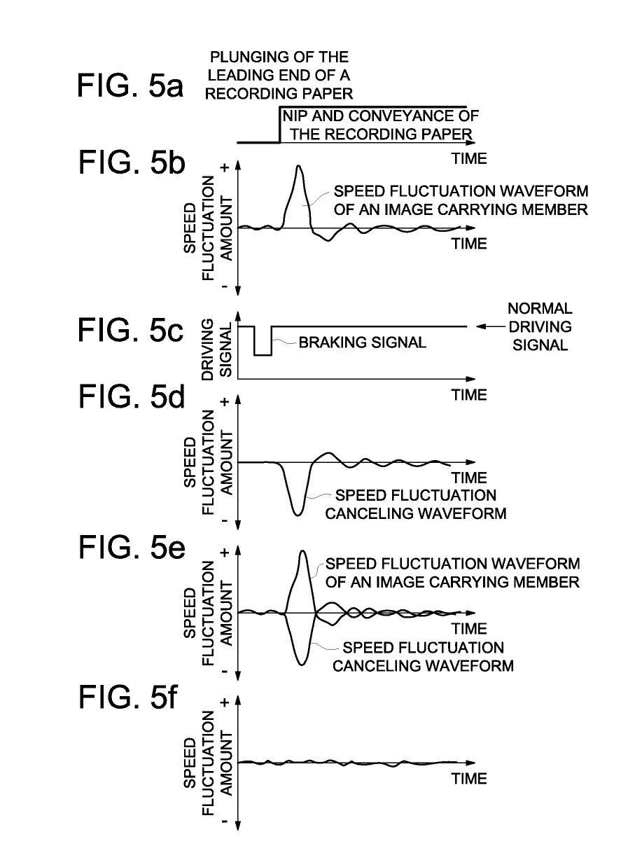

Hereafter, an explanation is made for operations in the image forming system comprising the image forming apparatus 200 of this embodiment with reference to a drawing for explaining detection of speed fluctuation in FIG. 3, a flowchart of FIG. 4, and a time chart of FIG. 5.

First, at the time that a process of forming toner images is started, or at the time that the power source of an image forming apparatus is turned on, an operator selects recording paper used for a process of forming toner images or a paper feeding tray, in which recording paper is stored, through the operating section 103 (Step S401 in FIG. 4).

Then, the control section 101 refers to information of recording paper or a paper feeding tray selected with reference to the job of the started process of forming toner images. Subsequently, the control section 101 reads out the specification data of the selected recording paper, and judges whether or not it is necessary to apply torque with the reverse phase for canceling speed fluctuation (Step S402 in FIG. 4).

Namely, in the case that the amount of speed fluctuation is expected to be smaller than a predetermined value due to the reasons that recording paper is very thin (No at Step S402 in FIG. 4), there is a possibility that the application of torque with the reverse phase causes the adverse effect without canceling the speed fluctuation in good order. Therefore, the control to apply the torque with the reverse phase is stopped, and until a series of the process of forming toner images is completed (No at Step S404 in FIG. 4), if recording paper is fed from the same paper feeding tray (No at Step 405 in FIG. 4), the process of forming toner images is conducted with the same method of conveying recording paper as the conventional one without applying torque with the reverse phase (Step 403 in FIG. 4).

Even in the course of the process that the series of the process of forming toner images is conducted (YES at Step S404 in FIG. 4), in the case that different recording paper is used for the purpose of classification (Yes at Step S405 in FIG. 4), the process returns to the judgment for the kind of recording paper (Step S401, S402 in FIG. 4) of YES), and the processes are executed from the beginning.

In the case that recording paper corresponds to those requiring the control to cancel speed fluctuation (YES at Step S402 in FIG. 4), in order to acquire speed fluctuation data corresponding to the selected recording paper (paper feeding tray), the control section 101 controls a designated tray to feed out a sheet of recording paper (Step S406 in FIG. 4), and controls the encoder 195 to detect the speed (speed fluctuation) of the intermediate transfer member driving roller 145R at the time that a sheet of recording paper passes through a transfer region. Then, from the encoder 195, the control section 101 acquires the amount of speed fluctuation generated at the time that the sheet of recording paper plunges into and leaves from the transfer region (Step S407 in FIG. 4). Simultaneously, from the encoder 195, the control section 101 acquires the generation timing of the speed fluctuation.

In this case, for each state at the time that the leading end of a sheet of recording paper plunges into the transfer region, at the time that the leading end of the sheet of recording paper plunges into the fixing section while the sheet of recording paper is pinched in the transfer region, at the time that the trailing end of the sheet of recording paper leaves from a registering section while the sheet of recording paper is pinched in the transfer region, and at the time that the sheet of recording paper leaves from the transfer region, the amount of speed fluctuation and the generation timing of the speed fluctuation corresponding to each kind of recording paper are detected and stored in the memory section 105 as speed fluctuation data in tables shown in FIG. 3b and FIG. 3c.

At the time that the leading end of a sheet of recording paper plunges into the transfer region on the condition that the transfer roller 176b is in contact with the intermediate transfer member 175, since the leading end of a sheet of recording paper pushes up the transfer roller 176b, it is considered that the speed fluctuation on the intermediate transfer member driving roller 145R is influenced by the thickness of the recording paper. Here, the thickness of recording paper is represented with its basic weight (weight in a predetermined size). However, depending on the difference in the density of recording paper, the basic weight is not proportional perfectly to the thickness. Therefore, the data of speed fluctuation corresponding to each kind of recording paper has been acquired in advance on the basis of the difference in paper quality such as regular paper and coated paper in addition to the respective basic weights.

When plural kinds of recording paper are set in the plural paper feeding trays of the image forming apparatus, since the control section 101 makes the memory section 105 to memorize the relationship between the plural kinds of recording paper and the plural paper feeding trays, the relationship between the weight of recording paper and the amount of speed fluctuation is made to correspond to the relationship between a paper feeding tray storing with the allotted recording paper and the amount of speed fluctuation (control data).

Moreover, since the generation timing of speed fluctuation may differ a little depending on the kind of recording paper, the generation timing of speed fluctuation has been acquired in advance for each kind of recording paper, and the correspondence relationship between a paper feeding tray allotted a kind of recording paper and the generation timing of speed fluctuation are memorized in the memory section 105 for each kind of recording paper.

Actually, speed fluctuation data (the amount of speed fluctuation and the occurrence timing of the speed fluctuation) may be stored as control data, or a braking signal to apply a reverse phase torque and an application timing to apply the reverse phase torque are produced based on the speed fluctuation data, and the braking signal and the may be stored as control data.

In the above operations, when the acquisition of speed fluctuation data cannot be conducted normally, the above processes are repeated (No at Step S408, and S406 in FIG. 4). During the acquisition of the speed fluctuation data (Step S407 in FIG. 4), in the case that speed fluctuation data remarkably different from the features (specification data) of recording paper was acquired (NO, at step S408 in FIG. 4), since it is expected that there was some abnormalities in the acquisition of speed fluctuation data, the conveyance of a sheet of recording paper and the acquisition of fluctuation data are repeated (Step S406 and S407 in FIG. 4). In order to judge such normal or abnormal, it is desirable that a permissible range of speed fluctuation data is stored beforehand in the memory section 105 for each specification data of recording paper and the control section 101 compares speed fluctuation data with the permissible range.

If the above process of acquiring speed fluctuation data is executed as a recording paper conveyance test separately from a usual process of forming toner images, it becomes possible to acquire speed fluctuation data without giving bad influence to a process of forming toner images, also without giving an adverse effect on the formed images at the time of a process of forming toner images.

And then, after the speed fluctuation data has been acquired in the above way, in order to cancel the speed fluctuation, a braking signal to generate speed components with a speed fluctuation canceling waveform is added to a normal driving signal and the driving signal including the braking signal is sent to the driving motor 135. Then, the driving motor 135 applies the reverse phase torque onto the intermediate transfer member driving roller 145R based on the driving signal so as to generate speed components with a speed fluctuation canceling waveform. Accordingly, a process of forming toner images is executed in order to cancel speed fluctuation in such a way that the registering roller 161 conveys a sheet of recording paper to the transfer region while the control section conducts a control to apply the reverse phase torque (Steps S409 to S414 in FIG. 4).

Therefore, in order to cancel speed fluctuation, firstly, the control section 101 reads out the control data corresponding to the selected recording paper from the memory section 105, produces a driving signal to generate speed components with a speed fluctuation canceling waveform corresponding to an amount of speed fluctuation and a generation timing of the speed fluctuation, and send the driving signal to the driving motor 135 (Step S409 in FIG. 4). Namely, at the timing that a sheet of recording paper plunges into the transfer region between the intermediate transfer member 175 and the transfer roller 176b (in FIG. 5a, L→H: a rising pulse), the speed fluctuation occurs such that speed rises momentarily. This is because it is considered that a sheet of recording paper being conveyed by the registering roller 161 located at the upstream side plunges into the transfer region on the condition that the transfer roller 176b comes in contact with the intermediate transfer member 175.

At this time, depending on the difference in the kind (thickness and weight) of the recording paper, the occurring speed fluctuation may differ in amplitude and generation timing.

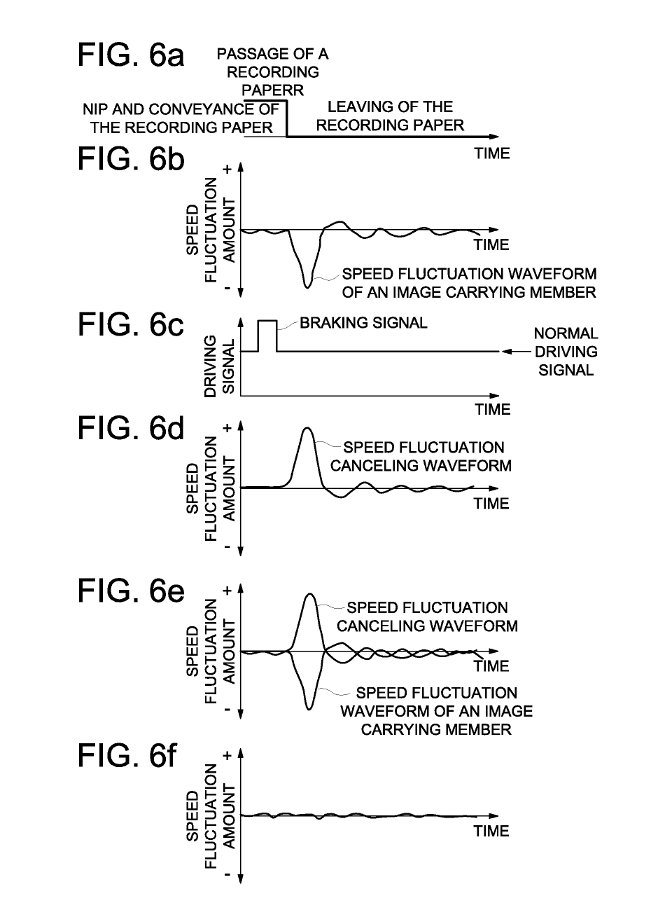

Further, at the timing that the trailing end of a sheet of recording paper has passed (left from) the transfer region between the intermediate transfer member 175 and the transfer roller 176b (in FIG. 6a H→L: falling pulse), as shown in FIG. 6b, the speed fluctuation occurs such that speed falls momentarily. This is because it is considered that the sheet of recording paper being conveyed by the fixing rollers 181, 182 located at the downstream has not existed between the intermediate transfer member 175 and the transfer roller 176b and the transfer roller 176b comes again in contact with the intermediate transfer member 175.

Further, at this time, depending on the difference in the kind (thickness and weight) of the recording paper, the occurring speed fluctuation may differ in amplitude and generation timing.

Then, when recording paper is conveyed during the process of forming toner images, a braking signal is added to a normal driving signal and the driving signal including the braking signal is sent to the driving motor 135. Thus, based on the braking signal, the driving motor 135 applies the reverse phase torque onto the intermediate transfer member driving roller 145R so as to generate speed components with a speed fluctuation canceling waveform to cancel the speed fluctuation. Therefore, since the intermediate transfer member 175 is driven by the intermediate transfer member driving roller 145R, the reverse phase torque based on the braking signal is also applied onto the intermediate transfer member 175 through the intermediate transfer member driving roller 145R. Then, on the condition that the reverse phase torque can be applied onto the intermediate transfer member 175, a sheet of recording paper is conveyed to the transfer region between the transfer roller 176b and the intermediate transfer member 175. Accordingly, speed fluctuation capable of being generated in the transfer region is cancelled by a speed component in the speed fluctuation canceling waveform generated on the intermediate transfer member 175 by the application of the reverse phase torque. As a result, since speed fluctuation is not generated in the transfer region, a process of forming toner images can be conducted without being influenced by the possible speed fluctuation. (Step S410 in FIG. 4).

Here, the correspondence relationship between speed fluctuation data (an amount of speed fluctuation and a generation timing of speed fluctuation) and the data of a braking signal to apply the reverse phase torque to generate speed components with a speed fluctuation canceling waveform is prepared based on the speed fluctuation data detected at the time of a recording paper conveyance test and stored as control data in the memory section 105 (FIG. 4 steps S401-S408). Then, at the time of a usual process of forming toner images, the control section 101 reads out a braking signal corresponding to the speed fluctuation data detected in the recording paper conveyance test from the control data in the memory section 105, and sends a driving signal including the braking signal to the driving motor 135, whereby the driving motor 135 applies the reverse phase torque corresponding to the braking signal onto the intermediate transfer member driving roller 145R.

Until the reverse phase torque works actually on the intermediate transfer member driving roller 145R, there is some delay due to the influence of the driving motor 135 and the speed reducing section 145. Therefore, since it is necessary to send the driving signal including the braking signal beforehand by the time corresponding to the delay, it is desirable to store the delay in the memory section 105.

As mentioned above, the control section 101 supplies driving signals including a braking signal (shown in FIG. 5c, FIG. 6c) corresponding to each kind of recording paper to the driving motor 135, and controls the driving motor 135 to apply the reverse phase torque to the intermediate transfer member driving roller 145R. Then, the control section 101 executes a process of forming toner images such that a sheet of recording paper is fed and conveyed to the transfer region under the above control.

At this time, although a braking signal to apply the reverse phase torque is added to the driving signal at a certain timing, there is some delay due to the influence of the driving motor 135 and the speed reducing section 145 until the reverse phase torque works actually on the intermediate transfer member driving roller 145R. Then, the braking signal to apply the reverse phase torque is added into the driving signal beforehand by a predetermined timing such that the peak of the speed fluctuation component (shown in FIG. 5b, FIG. 6b) corresponds to the bottom of the speed components with the speed fluctuation canceling waveform generated by the application of the reverse phase torque (shown in FIG. 5d, FIG. 6d).

Here, as the braking signal to apply the reverse phase torque, a braking signal as shown in FIG. 5c to reduce a driving signal only for a predetermined period is added to the driving against a speed fluctuation component which momentary rises up as shown in FIG. 5b. By the effect of this braking signal, a momentary lowering speed fluctuation component as shown in FIG. 5d is generated. This momentary lowering speed fluctuation component corresponds to the speed component with the reverse phase speed fluctuation canceling waveform against the speed fluctuation component caused by the influence of the sheet of recording paper as shown in FIG. 5b.

Further, as the braking signal to apply the reverse phase torque, a braking signal as shown in FIG. 6c to increase a driving signal only for a predetermined period is added to the driving signal against a speed fluctuation component as shown in FIG. 6b which momentary falls down. By the effect of this braking signal, a momentary rising speed fluctuation component as shown in FIG. 6d is generated. This momentary lowering speed fluctuation component corresponds to the speed component with the reverse phase speed fluctuation canceling waveform against the speed fluctuation component caused by the influence of the sheet of recording paper as shown in FIG. 6b.

As mentioned above, when the reverse phase torque is applied onto the intermediate transfer member driving roller 145R so as to generate speed components in the speed fluctuation canceling waveform with the matched amplitude at the matched timing, the speed of the intermediate transfer member driving roller 145R and the intermediate transfer member 175 becomes the state that the speed fluctuation component and the reverse phase speed fluctuation component are cancelled to each other (FIGS. 5e, 5f, and FIGS. 6e, 6f).

In the above case, as one example, a rectangular-shaped braking signal is employed as the braking signal to apply the reverse phase torque for descriptive purpose. However, it is desirable that the shape of the braking signal is made to a proper shape corresponding to the speed fluctuation waveform acquired at the time of the recording paper conveyance test.

Until a series of the process of forming toner images is completed (YES at Step S413 in FIG. 4), if a sheet of recording paper is fed from the same paper feeding tray (NO at Step S414 in FIG. 4), the intermediate transfer member driving roller 145R is driven by the driving motor 135 based on the driving signal into which the above-mentioned braking signals are added (Step S409, S410 in FIG. 4).

However, even if a series of the process of forming toner images is being conducted (YES at Step S413 in FIG. 4), in the case that different recording paper is used for the purpose of classification (No at Step S411 in FIG. 4), the process returns to selection and judgment for the kind of recording paper (Step S401, S402 in FIG. 4) of YES), and the processes are executed from the beginning.

In the case that the feature (specification data) of the set-up recording paper is a predetermined one, the control may be made not to apply the reverse phase torque. With this, it becomes possible to conduct an appropriate control corresponding to the specification data of each kind of recording paper, and even in the case unnecessary to conduct such a control, an appropriate condition may be established.

In the above operations, the control section 101 refers speeds at each section and respective detection timings of the recording paper sensors 165s1 to 165s3 located at the upstream side of each roller, and the control section 101 controls to apply the reverse phase torque at a suitable timing.

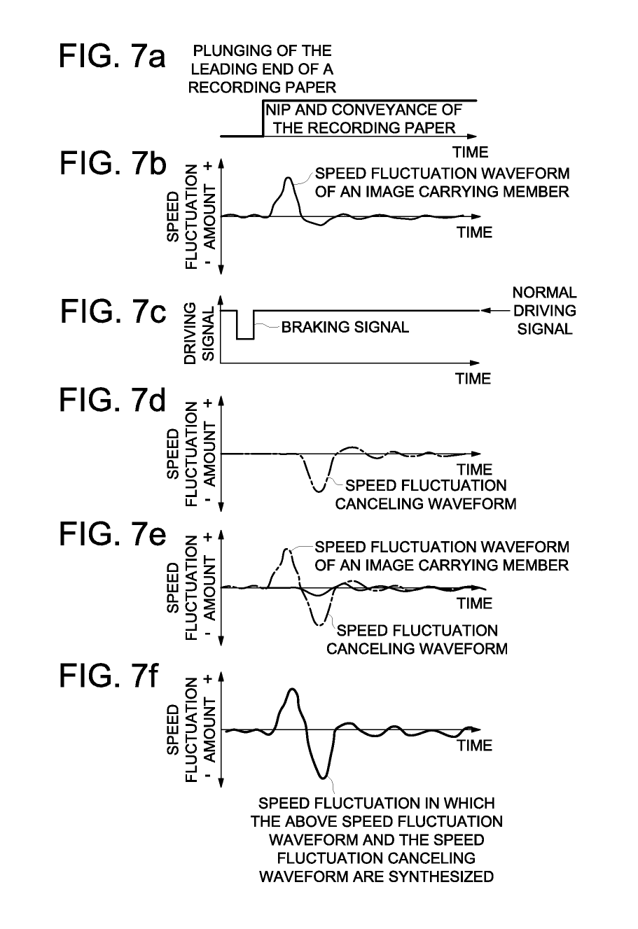

For example, at the timing that a sheet of recording paper plunges into the transfer region between the intermediate transfer member 175 and the transfer roller 176b (in FIG. 7a L→H: rising pulse), speed fluctuation occurs such that speed rises momentarily as shown in FIG. 7b. Then, at the time that a sheet of recording paper is conveyed during the process of forming toner images, a braking signal is added to a normal driving signal of the driving motor 135, and the driving signal including the braking signal apply the reverse phase torque is supplied to the driving motor 135, whereby the reverse phase torque is applied onto the intermediate transfer member driving roller 145R so as to generate speed components with the speed fluctuation canceling waveform (FIGS. 7c, 7d).

However, at this time, when a sheet of recording paper is conveyed at a timing different from an expected timing, as shown in FIG. 7e, the speed fluctuation canceling waveform becomes the condition that the phase of the speed fluctuation canceling waveform is deviated from that of the speed fluctuation waveform. As a result, the fluctuation of the speed fluctuation canceling waveform having the deviated timing is added to the wave shape of the speed fluctuation, which results in the condition that the fluctuation will be amplified as shown in FIG. 7f. Alternately, although the timing does not deviate too much to the above extent, the condition may results in that speed fluctuation similarly remains without being canceled.

Then, in this embodiment, the passage timing of a sheet of recording paper is detected by the recording paper sensors 165s1 to 165s3 arranged just before each roller. With these recording paper sensors, the generation timing of fluctuation has been detected beforehand, and further, the speed of each part and the conveying timing of a sheet of recording paper are detected, whereby based on these detection results, the control is made to cancel speed fluctuation properly at the correct timing. Accordingly, the speed fluctuation is cancelled properly so that the condition shown in FIG. 7f is not caused.

### Operations in the Structure of the Second Embodiment

Hereafter, the second embodiment of the present invention will be described.

As an image forming apparatus applicable with the second embodiment, it is similar to the image forming apparatus (shown in FIG. 1 and FIG. 2) in the above-mentioned first embodiment.

As shown in the above FIG. 7, when a generation timing of speed fluctuation or the generation timing of a speed fluctuation canceling waveform deviates, there is a possibility that it becomes impossible to execute a suitable speed fluctuation cancellation.

Then, during the execution of the usual process of forming images in which braking signal to apply the reverse phase torque are added, the control section 101 refers respective detection timings of the recording paper sensors 165s1 to 165s3 arranged at the upstream of each roller, and the control section 101 monitors whether there is a deviation in the conveyance timing of a sheet of recording paper or whether there is a deviation in the occurrence timing of speed fluctuation acquired from the encoder 195 (Step S411 in FIG. 4).

Further, in addition to the monitoring of deviation in the above various timings, the control section 101 refers the data of speed fluctuation acquired from the encoder 195 and monitors the remaining speed fluctuation after the application of the reverse phase torque to generate speed components with a speed fluctuation canceling waveform (Step S411 in FIG. 4).

In the case that there are deviations in the various timings during the process of forming toner images from the beginning, the process of forming toner images becomes the condition that the remaining speed fluctuation remains a predetermined value or more as shown in FIG. 7f (NO at Step S412 in FIG. 4). Accordingly, the control data are revised based on the fluctuation timing detected by the recording paper sensors and the remaining speed fluctuation detected by the encoder, and the revised control data are stored in the memory section 105 (Step S415 in FIG. 4). Accordingly, for the next sheet of recording paper, a reverse phase torque is applied based on the revised control data onto the intermediate transfer member driving roller 145R so as to generate a speed component with the revised speed fluctuation canceling waveform, thus the process of forming toner images is conducted based on the revised control data (Step S410 in FIG. 4).

In this way, the reverse phase torque is added to cause speed components in a speed fluctuation canceling waveform having a generation timing coincident with the occurrence timing of the speed fluctuation, whereby the speed of the intermediate transfer member driving roller 145R and the intermediate transfer member 175 becomes the condition that the speed fluctuation component is cancelled with the reverse phase speed component caused by the application of the reverse phase torque.

In this case, as same as step S402, if the amount of remaining speed fluctuation is less than a specified value, it is desirable not to generate new control data. In this way, the speed fluctuation can be canceled, whereby the process of forming toner images can be executed with high quality.

Further, in this case, if the amount of remaining speed fluctuation after the application of the reverse phase torque is still larger than a predetermined value, it is desirable that the control section 101 suspends the image forming operation for a moment, and displays a warning or sounds an alarm.

Namely, a control to cancel speed fluctuation is conducted as follows. The torque with a phase reverse to that of the expected speed fluctuation is applied so as to cancel the expected speed fluctuation caused on the intermediate transfer member 175 by vibration at the time of the passage of a sheet of recording paper through the transfer region. And then, after the cancellation of the expected speed fluctuation, speed fluctuation is detected again, and the cancellation of the speed fluctuation is repeated. In the above control, if the detected amount of remaining speed fluctuation is larger than a prescribed value regardless of the repeated cancellation, there may be the following possible problems: The kind of fed-out recording paper has been changed to a kind of recording paper beyond the scope of the assumption, or some problems take place on the control of an image forming apparatus. Therefore, it is desirable to suspend the image forming operations temporarily, to display warning or to sound alarm, whereby it becomes possible to execute the cancellation of speed fluctuation appropriately.

### Operations in the Structure of the Third Embodiment

Hereafter, the third embodiment of the present invention will be described.

As an image forming apparatus applicable with the third embodiment, it is similar to the image forming apparatus (shown in FIG. 1 and FIG. 2) in the above-mentioned first embodiment.

In the above embodiments, the recording paper conveyance test with regard to recording paper used for a process of forming toner images and the acquisition of fluctuation data are conducted at the time of starting a process of forming toner images (Steps S401 to S408 in FIG. 4), and then the process of forming toner images is executed in such a way that a sheet of recording paper is conveyed to the transfer region while the reverse phase torque to generate a speed component in the speed fluctuation canceling waveform works on the intermediate transfer member driving roller 145R (Steps S409 to S410 in FIG. 4).

For this reason, in the case that the recording paper (paper feeding tray) was changed to a different kind of recording paper in the course of a process of forming toner images and the speed fluctuation data to produce a speed fluctuation canceling waveform for the different kind of recording paper has not acquired, the process is needed to return to a recording paper conveyance test and the acquisition of speed fluctuation data for the different kind of recording paper (Steps S401 to S408 in FIG. 4).

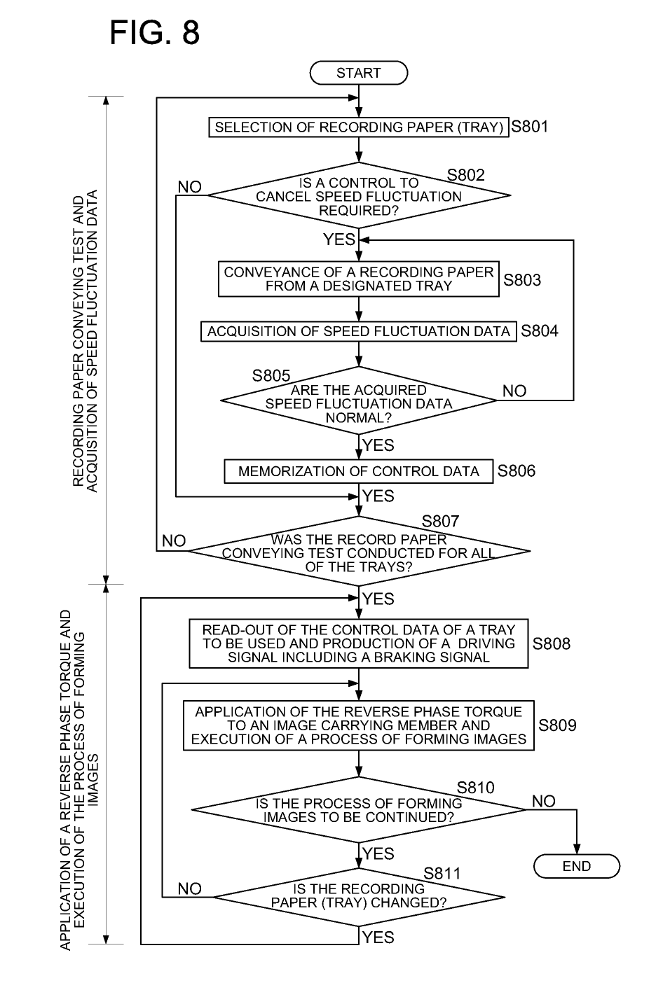

Then, in this third embodiment, for each tray which is installed in an image forming apparatus and accommodates recording paper, whether or not the accommodated recording paper requires the control to cancel speed fluctuation is judged (Steps S801 to S802 in FIG. 8), and a recording paper conveyance test is conducted for all the trays which accommodate recording paper requiring the control to cancel speed fluctuation, whereby the acquisition and memorization of speed fluctuation data is conducted beforehand (Step S807 in FIG. 8).

During the acquisition of such speed fluctuation data (Step S804 in FIG. 8), when speed fluctuation data remarkably different from the feature (specification data) of the recording paper are acquired (No at Step S805 in FIG. 8), since it is considered that some abnormalities take place in the acquisition of data, the recording paper conveyance test and the acquisition of speed fluctuation data are repeated (Step S803 and S804 in FIG. 8). In order to judge such normal or abnormal, it is desirable that a permissible range of speed fluctuation data is stored beforehand in the memory section 105 for each specification data of recording paper and the control section 101 compares speed fluctuation data with the permissible range.

With the above operations, before the usual process of forming toner images (Step S808 in FIG. 8) is executed, it becomes possible to acquire the amount of speed fluctuation and the generation timing of speed fluctuation for each tray shown in FIG. 3b and FIG. 3c. For a tray accommodating recording paper not requiring the control to cancel speed fluctuation, it is not necessary to acquire the speed fluctuation data as shown in FIG. 3b and FIG. 3c.

And then, after the acquisition of the speed fluctuation data of each tray has been completed (YES at Step S807 in FIG. 8), a process of forming toner images is executed in such a way that a sheet of recording paper is conveyed into the transfer region while the intermediate transfer member driving roller 145R is applied with the reverse phase torque to generate a speed component in a speed fluctuation canceling waveform corresponding to the speed fluctuation data (Steps S808 to S810 in FIG. 8).

In the case that the paper feeding tray is changed to another paper feeding tray during a process of forming toner images, or in the case that a process of forming toner images is continued by the use of another tray due to out of paper in the paper feeding tray being currently used, the control section 101 reads out the control data of the another proper tray without returning the recording paper conveyance test (Yes at Step S811 in FIG. 8) and the control section 101 controls based on the control data of the changed another tray such that the intermediate transfer member driving roller 145R is applied with the reverse phase torque to generate a speed component in a speed fluctuation canceling waveform corresponding to the speed fluctuation data of the changed another tray (Step S809 in FIG. 8), whereby the process of forming toner images can be continued (Step S810 in FIG. 8).

In this third embodiment, during the execution of a process of forming toner images, the detection of an occurrence timing of speed fluctuation and the detection of the amount of remaining speed fluctuation may be also executed, and then the control data including a braking signal to apply the reverse phase torque at a proper timing may be revised, or if the amount of the remaining speed fluctuation more than a predetermined level arises, the emission of warning and the like may be executed.

In this embodiment, a recording paper conveyance test and the acquisition of speed fluctuation data for each tray have been executed before a process of forming toner images, and thereafter the process of forming toner images is conducted. Therefore, since it becomes possible to continue the process of forming toner images without interruption, the productivity can be improved.

In this embodiment, when the feature of recording paper to be used is a predetermined one, it may be controlled not to apply the reverse phase torque. With this, a proper control can be executed in accordance with the feature of each kind of recording paper, and if recording paper does not require such a control to apply the reverse phase torque, the recording paper is handled properly without the application of such a control.

### Supplement of Each Embodiment

In the above embodiments, when an amount of speed fluctuation after the application of the reverse phase torque is smaller than a predetermined value, the revision of control data and the storage of the corrected speed fluctuation data are not conducted. With this, a proper control can be attained, and even if a control is not required, the operations can be maintained on a suitable condition.

Moreover, in the above embodiments, in the case that a recording paper conveyance test has been conducted for recording paper to be used for a process of forming toner images and the amount of speed fluctuation acquired by the test is below a predetermined value, a drive section will not apply the reverse phase torque at the time of a process of forming toner images. With this, a proper control can be attained, and even if a control is not required, the operations can be maintained on a suitable condition.

### Other Embodiment (1)

In the above embodiments, the explanations are made about the speed fluctuation caused by impulsive vibration at the time that a sheet of recording paper plunges into a transfer region structured such that the transfer roller 176b comes in contact with the intermediate transfer member 175 and leaves from the transfer region. However, the present invention is not limited to the above embodiments.

For example, on the condition that a sheet of recording paper is pinched and conveyed in the transfer region between the intermediate transfer member 175 and the transfer rollers 176b, when the leading end of the sheet of recording paper plunges into a conveying section (such as, between fixing rollers 181, 182 in the fixing section 180) adapted to nip and convey a sheet of recording paper at the downstream side of the transfer region, impulsive vibration also occurs.

In this case, if the passage of the leading end of the sheet of recording paper is detected by the recording paper sensor 165s3 arranged before the fixing roller 181, it becomes possible to grasp beforehand the timing that the leading end of a sheet of recording paper plunges into between the fixing rollers 181 and 182. Therefore, it also becomes possible to apply the reverse phase torque at a suitable timing.

Namely, when the impulsive vibration occurring at the conveying section (the fixing section 180) is transmitted through the sheet of recording paper to the intermediate transfer member 175 and causes speed fluctuation on the predetermined speed of the intermediate transfer member 175, it is possible to apply the reverse phase torque to the speed fluctuation of the intermediate transfer member 175. With this, it becomes possible to cancel the adverse effect of the impulsive vibration caused at the time that a sheet of recording paper plunges into a downstream conveying section while being pinched and conveyed in the transfer region between an image carrying member and a transfer section. In this explanation, the fixing rollers 181, 182 are taken as an example of the downstream conveying section. However, another conveying section other than the fixing section 180 may be also applicable with this cancellation control.

### Other Embodiment (2)

In the above embodiments, the explanations are made about the speed fluctuation caused by impulsive vibration at the time that a sheet of recording paper plunges into a transfer region where the transfer roller 176b comes in contact with the intermediate transfer member 175 and leaves from the transfer region. However, the present invention is not limited to the above embodiments.

For example, on the condition that sheet of recording paper is pinched and conveyed in the transfer region between the intermediate transfer member 175 and the transfer rollers 176b, when the trailing end of the sheet of recording paper passes (leaves) a conveying section (such as, registering rollers 161) adapted to nip and convey a sheet of recording paper at the upstream side of the transfer region, impulsive vibration also occurs. When this impulsive vibration is transmitted through the sheet of recording paper to the intermediate transfer member 175 and causes speed fluctuation on the predetermined speed of the intermediate transfer member 175, it is possible to apply the reverse phase torque to the speed fluctuation of the intermediate transfer member 175.

In this case, if the passage of the trailing end of the sheet of recording paper is detected by the recording paper sensor 165s1 arranged before the registering rollers 161, it becomes possible to grasp beforehand the timing that the trailing end of the sheet of recording paper passes the registering rollers 161. Therefore, it also becomes possible to apply the reverse phase torque at a suitable timing.

With this, it becomes possible to cancel the adverse effect of impulsive vibration caused at the time that the trailing end of a sheet of recording paper passes an upstream conveying section while being pinched and conveyed in the transfer region between an image carrying member and a transfer section. In this explanation, the registering rollers 161 are taken as an example of the upstream conveying section. However, another conveying section other than the registering roller may be also applicable with this cancellation.

### Other Embodiment (3)

In the above embodiments, the explanations are made about the speed fluctuation caused by impulsive vibration at the time that a sheet of recording paper plunges into a transfer region where the transfer roller 176b comes in contact with the intermediate transfer member 175 and leaves from the transfer region. However, the present invention is not limited to the above embodiments. For example, instead of the intermediate transfer member 175, in the case that speed fluctuation is caused by impulsive vibration occurring when the sheet of recording paper plunges into or leaves between a photoreceptor drum and a transfer roller, it is also possible to attain a good result by the application of the reverse phase torque similarly.

### Other Embodiment (4)

In the above explanations, it is possible to combine the above embodiments and conduct the combined embodiments, whereby a good result can be acquired.

### Other Embodiment (5)

In the above explanations for each embodiment, the timing to generate a speed fluctuation canceling waveform is made to be changed in accordance with the conveying timing of a sheet of recording paper detected by the recording paper sensors 165s1 to 165s3 and the like.

However, in contrast to the above, it is also possible to match the timing to cause speed fluctuation with the timing to generate a speed fluctuation canceling waveform by accelerating or reducing the conveyance speed of a sheet of recording paper based on the conveying timing of the sheet of recording paper detected by the recording paper sensor 165s1 to 165s3 and the like.

Alternatively, while accelerating or reducing the conveyance speed of a sheet of recording paper based on the conveyance timing of the sheet of recording paper detected by the recording paper sensor 165s1 to 165s3 and the like, it is also possible to match the timing to cause speed fluctuation with the timing to generate a speed fluctuation canceling waveform by controlling the timing to generate the speed fluctuation canceling waveform.

### Other Embodiment (6)

In the above explanations, the monochromatic image forming apparatus is taken as the specific example. However, the present invention is not limited to this example. Even if the present invention is applied to a color image forming apparatus, it is also possible to acquire a good result.

According to the present invention, the following effects can be acquired.

In the image forming apparatus described in Item 1, based on control data held by the memory section, against fluctuation (speed fluctuation) provided on a predetermined speed of an image carrying member by vibration occurring at the time that a sheet of recording paper passes between the image carrying member and the transfer section, the control section makes the driving section to apply the reverse phase torque at the same timing equal as the generation timing of the speed fluctuation.

In this embodiment, since the reverse phase torque is applied at the same timing as the generation timing of the speed fluctuation so as to cancel speed fluctuation caused by vibration occurring at the time that a sheet of recording paper passes, there is no need to slack a belt. Further, even in the case that the image carrying member is a drum, not a belt, it is also possible to cope with the speed fluctuation. Therefore, there is no need to enhance the mechanical rigidity of the entire body of the image forming apparatus or to use elastic rollers. As a result, speed fluctuation of an image carrying member caused by sudden vibration can be suppressed without deteriorating image quality, whereby it is possible to avoid the deterioration of image quality.

In the image forming apparatus described in Item 2, the control section refers the control data corresponding to the sheet of recording paper to be used for a process of forming toner images among the control data held by the memory section in accordance with the kind of recording paper, and makes the drive section to apply the reverse phase torque against speed fluctuation provided on a predetermined speed of the image carrying member by vibration occurring at the time that the sheet of recording paper passes between the image carrying member and the transfer section. With this, it becomes possible to cancel speed fluctuation properly based on the control data coincident with the recording paper.

In Item 1, according to Item 2, in the case that the memory section holds a plurality of control data corresponding to the plural kinds of recording paper, the control section refers the control data corresponding to the recording paper to be used for a process of forming toner images among the plurality of control data corresponding to the plural kinds of recording paper held in the memory section, and makes the drive section to apply the reverse phase torque against fluctuation (speed fluctuation) provided on a predetermined speed of the image carrying member by vibration occurring at the time that the sheet of recording paper passes between the image carrying member and the transfer section. With this, even in the case that there exist plural kinds of recording paper, it becomes possible to cancel speed fluctuation properly based on the control data coincident with the recording paper to be used.

In the image forming apparatus described in Item 3, the generation timing of speed fluctuation is detected and memorized in the memory section, based on the control data held in the memory section, against fluctuation (speed fluctuation) provided on a predetermined speed of the image carrying member by vibration occurring at the time that the sheet of recording paper passes between the image carrying member and the transfer section, the control section makes the drive section to apply the reverse phase torque at the same timing as the generation timing of the speed fluctuation.

In this embodiment, since the reverse phase torque is applied precisely at the same timing as the generation timing of the detected and memorized speed fluctuation so as to cancel speed fluctuation caused by vibration occurring at the time that a sheet of recording paper passes, there is no need to slack a belt. Further, even in the case that the image carrying member is a drum, not a belt, it is also possible to cope with the speed fluctuation. Therefore, there is no need to enhance the mechanical rigidity of the entire body of the image forming apparatus or to use elastic rollers. As a result, speed fluctuation of an image carrying member caused by sudden vibration can be suppressed without deteriorating image quality, whereby it is possible to avoid the deterioration of image quality. Further, when the reverse phase torque is applied with the same timing of the occurring speed fluctuation, instantaneous speed fluctuation caused by vibration can be cancelled properly.

In the image forming apparatus described in Item 4, the image forming apparatus is provided with a recording paper sensor to detect the passage of the sheet of recording paper at the upstream side of a roller to nip and convey the sheet of recording paper, and the control section controls the timing to convey the sheet of recording paper in accordance with the detection result of the recording paper sensor such that the timing of the reverse phase torque generated by the driving section becomes the same timing of fluctuation (speed fluctuation) caused by vibration occurring at the time that a sheet of recording paper passes between the image carrying member and the transfer section. With this, it becomes possible to cancel speed fluctuation properly based on the control data coincident with the conveyance of recording paper.

In the image forming apparatus described in Item 5, the control section conveys a sheet of recording paper to be used for forming an image, detects an amount of speed fluctuation provided on a predetermined speed of the image carrying member by vibration occurring at the time that the sheet of recording paper passes between the image carrying member and the transfer section, and makes the memory section to memorize the control data corresponding to the fluctuation, and at the time of forming an image, based on the control data held by the memory section, against speed fluctuation provided on a predetermined speed of the image carrying member by vibration occurring at the time that the sheet of recording paper passes between the image carrying member and the transfer section, the control section makes the drive section to apply the reverse phase torque at the same timing as the generation timing of the speed fluctuation.

In this embodiment, before a process of forming toner images, a sheet of recording paper is conveyed, and speed fluctuation caused by vibration occurring during the passage of the sheet of recording paper is detected. With this, at the time of forming an image, the image carrying member becomes the condition that the speed fluctuation has been cancelled, it becomes possible to form an image while maintaining good image quality.

Namely, firstly, the timing of speed fluctuation is detected, and since the reverse phase torque is applied at the same timing as the generation timing of the detected speed fluctuation so as to cancel the speed fluctuation caused by vibration occurring at the time that a sheet of recording paper passes, there is no need to slack a belt. Further, even in the case that the image carrying member is a drum, not a belt, it is also possible to cope with the speed fluctuation. Therefore, there is no need to enhance the mechanical rigidity of the entire body of the image forming apparatus or to use elastic rollers. As a result, speed fluctuation of an image carrying member caused by sudden vibration can be suppressed without deteriorating image quality, whereby it is possible to avoid the deterioration of image quality. Further, if the reverse phase torque is applied with the same timing of the occurring speed fluctuation, instantaneous speed fluctuation caused by vibration can be cancelled properly.

In the image forming apparatus described in Item 6, the image forming apparatus is provided with plural steps of paper feeding trays to accommodate recording paper therein, and the control section detects the generation timing of the speed fluctuation by the conveyance of a sheet of recording paper for each kind of recording paper accommodated in the plural steps of paper feeding trays and makes the memory section to memorize the generation timing or the control data corresponding to the respective paper feeding trays. And then, at the time of forming an image, based on the control data held by the memory section, against fluctuation (speed fluctuation) provided on a predetermined speed of the image carrying member by vibration occurring at the time that the sheet of recording paper passes between the image carrying member and the transfer section, the control section makes the drive section to apply the reverse phase torque at the same timing as the generation timing of the speed fluctuation. With this, when the reverse phase torque is applied with the same timing of the occurring speed fluctuation, instantaneous speed fluctuation caused by vibration can be cancelled properly.

In the image forming apparatus described in Item 7, the image forming apparatus is provided with plural paper feeding trays to accommodate recording paper therein and a setting section to set the feature or the specification data (kind (regular paper/coated paper, etc.) weight, size and the like) of recording paper, and the control section detects the generation timing of the speed fluctuation by the conveyance of a sheet of recording paper for recording paper accommodated in each of the plural paper feeding trays and makes the memory section to memorize the generation timing or the control data corresponding to the feature or the specification data of recording paper for each of recording paper of the respective paper feeding trays. With this, it becomes possible to conduct control corresponding to the feature of each recording paper.

Before a process of forming toner images, if the timing of fluctuation is detected for recording paper of each tray, even when the tray being currently used is changed to another tray during the process of forming toner images, it is possible to continue a process of forming toner images without conducting the paper conveyance test.

In the image forming apparatus described in Item 8, the image forming apparatus is provided with a recording paper sensor to detect the passage of the sheet of recording paper at the upstream side of a roller to nip and convey the sheet of recording paper, and the control section controls the timing to convey the sheet of recording paper in accordance with the detection result of the recording paper sensor such that the timing of the reverse phase torque generated by the driving section becomes the same timing of the fluctuation (speed fluctuation) caused by vibration occurring at the time that the sheet of recording paper passes between the image carrying member and the transfer section. With this, it becomes possible to cancel speed fluctuation properly based on the control data coincident with the conveyance of recording paper.

In the image farming apparatus described in Item 9, at the time of forming an image, the control section detects the generation timing of speed fluctuation and makes the memory section to memorize the generation timing, and at the next time of forming an image, based on the control data held by the memory section, against fluctuation (speed fluctuation) provided on a predetermined speed of the image carrying member by vibration occurring at the time that the sheet of recording paper passes between the image carrying member and the transfer section, the control section makes the drive section to apply the reverse phase torque at the same timing as the generation timing of the speed fluctuation.

In this embodiment, since the reverse phase torque is applied precisely at the same timing as the generation timing of the detected and memorized speed fluctuation so as to cancel speed fluctuation caused by vibration occurring at the time that a sheet of recording paper passes, there is no need to slack a belt. Further, even in the case that the image carrying member is a drum, not a belt, it is also possible to cope with the speed fluctuation. Therefore, there is no need to enhance the mechanical rigidity of the entire body of the image forming apparatus or to use elastic rollers. As a result, speed fluctuation of an image carrying member caused by sudden vibration can be suppressed without deteriorating image quality, whereby it is possible to avoid the deterioration of image quality. Further, when the reverse phase torque is applied with the same timing of the occurring speed fluctuation, instantaneous speed fluctuation caused by vibration can be cancelled properly.

In the image forming apparatus described in Item 10, based on the control data held by the memory section, against fluctuation (speed fluctuation) provided on the image carrying member by vibration occurring at the time that the sheet of recording paper passes between the image carrying member and the transfer section, the control section makes the drive section to apply the reverse phase torque at the same timing as the generation timing of the occurring speed fluctuation, detects an amount of speed fluctuation after the rectification having applied the reverse phase torque, and makes the memory section to memorize the control data revised in accordance with the amount of speed fluctuation after the rectification, and at the next time of forming an image, the control section instructs the drive section to apply the reverse phase torque to the speed fluctuation at a timing equal to the generation timing of the speed fluctuation based on the revised control data and the generation timing of the speed fluctuation held by the memory section.

In this embodiment, since the speed fluctuation after the application of the reverse phase torque is detected and subjected to “feed-back”, it becomes possible to conduct control precisely in terms of timing and an amount of speed fluctuation by the application of the reverse phase torque, and speed fluctuation of an image carrying member caused by sudden vibration can be suppressed without deteriorating image quality, whereby it is possible to avoid the deterioration of image quality.

Namely, in this embodiment, firstly, fluctuation is detected, then, torque with a phase reverse to that of the detected fluctuation is generated so as to cancel speed fluctuation caused by vibration at the time that a sheet of recording paper passes. Further, an amount of speed fluctuation after the rectification by the cancellation is detected, and the cancellation of vibration is repeated. With this, an amount of speed fluctuation after the rectification can be made small sufficiently.

In the image forming apparatus described in Item 11, when the amount of speed fluctuation after the rectification is larger than a predetermined value, the control section stops the operations to form an image temporarily, or displays warning or issues warding sounds.

Namely, the control section generates the reverse torque to fluctuation so as to cancel speed fluctuation caused by vibration at the time that a sheet of recording paper passes, and the control section detects an amount of speed fluctuation after the rectification and repeats the cancellation of vibration. At this time, when the detected amount of speed fluctuation is larger than a predetermined value, since there is a possibility that a fed-out recording paper is changed to an unexpected recording paper suddenly, or some problems take place on the control of the image forming apparatus, the control section stops the operations to form an image temporarily, or displays warning or issues warding sounds. With this, it is possible to conduct the cancellation of speed fluctuation properly.

In Item A, that is, in the image forming apparatus described in any one of Items 1 to 11, the control section generates the reverse phase torque to the fluctuation (speed fluctuation) provided on a predetermined speed of the image carrying member by vibration occurring at the time that the leading end of the sheet of recording paper plunges into between the image carrying member and the transfer section. With this, it becomes possible to cancel the adverse effect of vibration occurring at the time that the leading end of a sheet of recording paper plunges into between the image carrying member and the transfer section.

In Item B, that is, in the image forming apparatus described in any one of Items 1 to 11, the control section generates the reverse phase torque to the fluctuation (speed fluctuation) provided on a predetermined speed of the image carrying member by vibration occurring at the time that the trailing end of the pinched sheet of recording paper passes between the image carrying member and the transfer section. With this, it becomes possible to cancel the adverse effect of vibration occurring at the time that the trailing end of a sheet of recording paper passes (leaves) between the image carrying member and the transfer section.

In Item C, that is, in the image forming apparatus described in any one of Items 1 to 11, on the condition that a sheet of recording paper is nipped between the image carrying member and the transfer section, the control section generates the reverse phase torque to the fluctuation (speed fluctuation) provided on a predetermined speed of the image carrying member by vibration occurring at the time that the leading end of the sheet of recording paper plunges into a conveying section to nip and convey the sheet of recording paper at a downstream side of the transfer section. With this, it becomes possible to cancel the adverse effect of vibration occurring at the time that on the condition that a sheet of recording paper is nipped between the image carrying member and the transfer section, the sheet of recording paper plunges into a conveying section at the downstream position.

In Item D, that is, in the image forming apparatus described in any one of Items 1 to 11, on the condition that a sheet of recording paper is nipped between the image carrying member and the transfer section, the control section generates the reverse phase torque to the fluctuation (speed fluctuation) provided on a predetermined speed of the image carrying member by vibration occurring at the time that the trailing end of the sheet of recording paper passes a conveying section to nip and convey the sheet of recording paper at a upstream side of the transfer section. With this, it becomes possible to cancel the adverse effect of vibration occurring at the time that on the condition that a sheet of recording paper is nipped between the image carrying member and the transfer section, the sheet of recording paper passes a conveying section at the upstream position.

In Item E, that is, in the above image forming apparatus, if the detected amount of the speed fluctuation or the memorized control data is less than a predetermined value, the control section does not instruct the driving section to apply the reverse phase torque.

That is, in the case that the reverse phase torque to fluctuation is generated so as to cancel speed fluctuation caused by vibration occurring at the time that a sheet of recording paper passes, if the detected amount of the speed fluctuation is less than a predetermined value, there is a possibility that the application of the reverse phase torque does not cancel fluctuation well and causes the reverse effect. Therefore, the control to apply the reverse phase torque is stopped. With this, it becomes possible to conduct the cancellation of speed fluctuation properly.

Further, in this embodiment, if an amount of speed fluctuation after the rectification is less than a predetermined level, the revision and memorization of the control data is not conducted. With this, a proper control can be conducted properly, and in the case that the control is not required, the operation is maintained on the proper condition.

Further, in this embodiment, if an amount of speed fluctuation acquired by the conveyance of a sheet of recording paper to be used for a process of forming toner images is less than a predetermined level, the control section makes the driving section not to apply the reverse phase torque. With this, a proper control can be conducted properly, and in the case that the control is not required, the operation is maintained on the proper condition.

What is claimed is:

1. An image forming apparatus, comprising:
an image carrying member for carrying a toner image;
a drive section for driving the image carrying member at a predetermined speed;
a transfer section for forming a transfer region with the image carrying member therebetween in which the transfer section nips a sheet of recording paper with the image carrying member so as to transfer the toner image on the image carrying member to the sheet of recording paper;
a memory section for memorizing control data to suppress speed fluctuation which is caused on the image carrying member when the sheet of recording paper passes the transfer region formed between the image carrying member and the transfer section; and
a control section to control the drive section based on the control data memorized in the memory section such that the drive section applies torque with a phase reverse to that of the speed fluctuation onto the image carrying member.

2. The image forming apparatus described in claim 1, wherein the memory section memorizes the control data for each of plural kinds of recording paper, and the control section controls the drive section based the control data corresponding to the kind of recording paper used for a process of forming toner images.

3. The image forming apparatus described in claim 2, further comprising:
a plurality of paper feeding trays for accommodating plural kinds of recording paper,
wherein the control section sets a relationship between a paper feeding tray and a kind of recording paper accommodated in the paper feeding tray, and makes the memory section to memorize the control data corresponding to the kind of recording paper with the relationship between the paper feeding tray and the kind of recording paper.

4. The image forming apparatus described in claim 1, further comprising:
a speed detecting section for detecting the speed of the image carrying member,
wherein the speed detecting section detects speed fluctuation of the image carrying member caused by vibration occurring at the time that the sheet of recording paper passes the transfer region formed between the image carrying member and the transfer member, and the control section makes the memory section to memorize the detected speed fluctuation as the control data.

5. The image forming apparatus described in claim 4, wherein after the drive section has applied the reverse phase torque onto the image carrying member, the speed detecting section further detects the speed of the image carrying member, and the control section revises the control data based on the detection result of the speed detecting section.

6. The image forming apparatus described in claim 5, wherein in the detection result of the speed detecting section after the drive section has applied the reverse phase torque onto the image carrying member, if the speed fluctuation of the image carrying member is still larger than a predetermined value, the control section stops a process of forming toner images temporarily, displays warning or issues warning sounds.

7. The image forming apparatus described in claim 1, further comprising:
a recording paper sensor for detecting that the sheet of recording paper passes at a predetermined position on a conveyance path,
wherein the control section controls the generation timing of the reverse phase torque based on the detection result of the recording paper sensor.

8. The image forming apparatus described in claim 1, wherein the control section controls the drive section to apply the reverse phase torque at least two times at the time that the sheet of recording paper plunges into the transfer region and at the time that the sheet of recording paper leaves from the transfer region.

9. The image forming apparatus described in claim 1, further comprising:
a conveying roller for conveying the sheet of recording paper to the transfer region; and
a recording paper sensor provided near the conveying roller, for detecting that the sheet of recording paper passes at a predetermined position on a conveyance path;
wherein the control section controls the generation timing of the reverse phase torque based on the detection result of the recording paper sensor.

10. The image forming apparatus described in claim 1, further comprising:
a fixing section for fixing the toner image transferred onto the sheet of recording paper;
wherein the control section controls the drive section to generate a reverse phase torque to cancel speed fluctuation on the image carrying member caused when the sheet of recording paper plunges into the fixing section.
